(19) United States
(12) Patent Application Publication
(10) Pub. No.: US 2013/0149908 A1
(43) Pub. Date: Jun. 13, 2013

(54) HERMAPHRODITIC BOARD TO BOARD CONNECTOR AND ASSEMBLY THEREOF WITH OFFSET CONTACT ARRANGEMENT

(71) Applicants: TERRANCE F. LITTLE, York, PA (US); HUNG-YANG YEH, New Taipei (TW)

(72) Inventors: TERRANCE F. LITTLE, York, PA (US); HUNG-YANG YEH, New Taipei (TW)

(73) Assignee: HON HAI PRECISION INDUSTRY CO., LTD., New Taipei (TW)

(21) Appl. No.: 13/315,549

(22) Filed: Dec. 9, 2011

(51) Int. Cl. H01R 24/28

(52) U.S. Cl. 439/660

(57) ABSTRACT

A hermaphroditic board to board connector assembly (300) includes identical and mateable plug and receptacle connectors (100, 200) each including an insulative housing (1) and a number of contacts (2) fixed in the insulative housing. The insulative housing (1) includes a first segment (11) and a second segment (12) connected by a connection wall (14) therebetween. Each of the first segment (11) and the second segment (12) includes opposite side walls with a cavity (110, 120) formed therebetween and a number of contact-receiving slots (113, 123) for receiving the contacts (2). The cavity (110) of the first segment (11) and the cavity (120) of the second segment (12) both extend along a longitudinal direction while offset from each other as viewed along the longitudinal direction. As a result, the structure of the insulative housing (1) is robust and normal forces thereof can also be well balanced.

### BACKGROUND OF THE INVENTION

1. Field of the Invention

The present disclosure relates to board to board connectors and an assembly thereof, and more particularly to hermaphroditic board to board connectors and an assembly thereof with robust housing structure and balanced normal forces.

2. Description of Related Art

Because of the continuing demand for smaller and slimmer portable electronic devices, it is necessary to develop these devices utilizing small form factor connectors, that provide a combination for overall space reduction, and reliable electrical contact, that will not compromise performance. Miniature low-profile board-to-board connectors offer maximum space savings for mobile devices, in order to meet surging market demand for downsizing of mobile portable devices. The development of these low-profile board-to-board connectors will provide maximum performance in a low profile form factor, with fine pitch. Conventional board-to-board connector assembly includes a plug connector and a receptacle connector mateable with each other. Normally, the plug connector and the receptacle connector have different structures as a result that different molds must be provided to manufacture each of them and almost the same quantities of the plug connectors and the receptacle connectors need to be prepared for customer requirements. However, under this arrangement, on one hand, the molding costs can be improved and on the other hand, it is difficult to reduce the inventory.

In order to solve these problems, U.S. Pub. No. 2009/0081903 published to Zhang et al. on Mar. 26, 2009 discloses a hermaphroditic board to board connector assembly including a plug connector and a receptacle connector identical with the plug connector. However, each of the plug connector and the receptacle connector includes a longitudinal insulative housing and multiple contacts installed in the insulative housing. The insulative housing includes a wide side wall and a narrow side wall opposite to the wide side wall with a single longitudinal slot formed therebetween. However, under this configuration, the structure of the insulative housing is weak and normal forces thereof when the plug connector and the receptacle connector get mated are unbalanced. As a result, it is not friendly for inserting the plug connector and the receptacle together.

Hence, it is desirable to provide hermaphroditic board to board connectors and an assembly thereof with improved contact arrangements and housing structures.

### BRIEF SUMMARY OF THE INVENTION

The present disclosure provides a hermaphroditic board to board connector assembly including a plug connector and a receptacle connector with a same configuration with the plug connector. The plug connector and the receptacle connector each includes an insulative housing and a plurality of first and second contacts fixed in the insulative housing. The insulative housing includes a first segment, a second segment and a connection wall connecting and located between the first segment and the second segment. The first segment includes a first side wall, a second side wall opposite to the first side wall with a first cavity formed therebetween, and a plurality of first contact-receiving slots each extending along a transverse direction. The second segment includes a third side wall, a fourth side wall opposite to the third side wall with a second cavity formed therebetween, and a plurality of second contact-receiving slots each extending along the transverse direction. The second side wall and the third side wall are opposite to each other. The first and the second contacts are respectively received in the first contact-receiving slots and the second contact-receiving slots and respectively protrude into the first cavity and the second cavity. The first cavity and the second cavity extend along a longitudinal direction perpendicular to the transverse direction while offset from each other as viewed along the longitudinal direction. When the plug connector and the receptacle connector are mated with each other, the first side wall of the plug connector is received in the first cavity of the receptacle connector and the second side wall of the plug connector is located sidewardly to the first side wall of the receptacle connector along the transverse direction, and the fourth side wall of the plug connector is received in the second cavity of the receptacle connector and the third side wall of the plug connector is located sidewardly to the fourth side wall of the receptacle connector along the transverse direction.

Besides, the present disclosure provides an electrical connector including a plurality of first pattern modules and a plurality of second pattern modules alternately connected with each other along a longitudinal direction. Each of the first pattern modules and each of the second pattern modules includes an insulative body comprising a bottom wall, a first side wall, a second side wall opposite to the first side wall with a cavity formed therebetween and a contact-receiving slot extending along a transverse direction perpendicular to the longitudinal direction, and a plurality of contacts received in the contact-receiving slot and protruding into the cavity. Each second pattern module can be achieved through rotating each first pattern module 180 degrees in a horizontal plane and then letting each first pattern module offset along the transverse direction. As a result, with the plug connector and the receptacle connector truly identical, costs thereof can be saved and inventory thereof can be reduced. Besides, under this configuration, the structure of the insulative housing is robust and normal forces thereof can also be well balanced.

The foregoing has outlined rather broadly the features and technical advantages of the present disclosure in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 is a perspective view of a board to board connector assembly with a plug connector and a receptacle connector mateable with each other in accordance with a first embodiment of the present disclosure;

FIG. 2 is another perspective view of the board to board connector assembly similar to FIG. 1, taken from another aspect;

FIG. 3 is a perspective view of the board to board connector assembly as shown in FIG. 1 with the plug connector separated from the receptacle connector;

FIG. 4 is another perspective view of the board to board connector assembly as shown in FIG. 1 with the plug connector revered 180 degrees around an arrow R to show that the plug connector and the receptacle connector have the same structure;

FIG. 5 is a perspective view of the plug connector or the receptacle connector as shown in FIG. 4;

FIG. 6 is another perspective view of the plug connector or the receptacle connector as shown in FIG. 5;

FIG. 7 is a top view of the plug connector or the receptacle connector as shown in FIG. 5;

FIG. 8 is an exploded view of the plug connector or the receptacle connector with contacts separated from an insulative housing;

FIG. 9 is a cross-sectional view of the board to board connector assembly before the plug connector and the receptacle connector are mated with each other;

FIG. 10 is a cross-sectional view of the board to board connector assembly taken along line 10-10 of FIG. 1 with the plug connector and the receptacle connector mating with each other and respectively mounted on two PCBs;

FIG. 11 is a cross-sectional view of the board to board connector assembly taken along line 11-11 of FIG. 1 with the plug connector and the receptacle connector respectively mounted on the two PCBs;

FIG. 12 is a perspective view of a board to board connector assembly with a plug connector and a receptacle connector mateable with each other and respectively mounted on the two PCBs in accordance with a second embodiment of the present disclosure;

FIG. 13 is a perspective view of the board to board connector assembly as shown in FIG. 12 with the plug connector separated from the receptacle connector;

FIG. 14 is another perspective view of the board to board connector assembly as shown in FIG. 13 with the plug connector revered 180 degrees around an arrow R to show that the plug connector and the receptacle connector have the same structure;

FIG. 15 is a perspective view of the plug connector or the receptacle connector as shown in FIG. 14;

FIG. 16 is an exploded view of the plug connector or the receptacle connector with contacts separated from an insulative housing;

FIG. 17 is an enlarged view of a circle portion as shown in FIG. 15 showing a first pattern module and a second pattern module;

FIG. 18 is a cross-sectional view of the board to board connector assembly with the plug connector and the receptacle connector respectively mounted on two PCBs and separated from each other;

FIG. 19 is a cross-sectional view of the board to board connector assembly taken along line 19-19 of FIG. 12 with the plug connector and the receptacle connector mating with each other and respectively mounted on the two PCBs; and

FIG. 20 is a cross-sectional view of the board to board connector assembly taken along line 20-20 of FIG. 12 with the plug connector and the receptacle connector respectively mounted on the two PCBs.

### DETAILED DESCRIPTION OF THE PREFERRED EMBODIMENTS

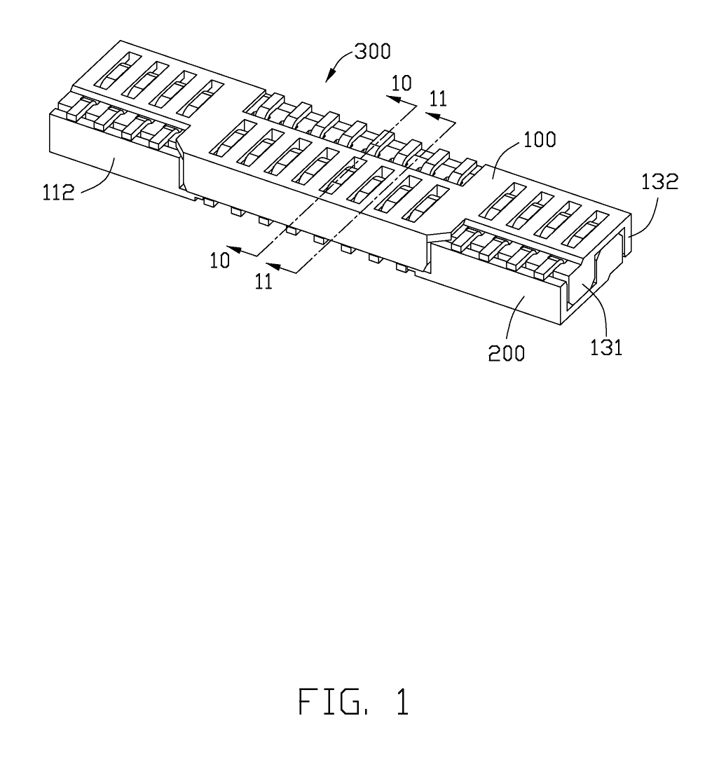

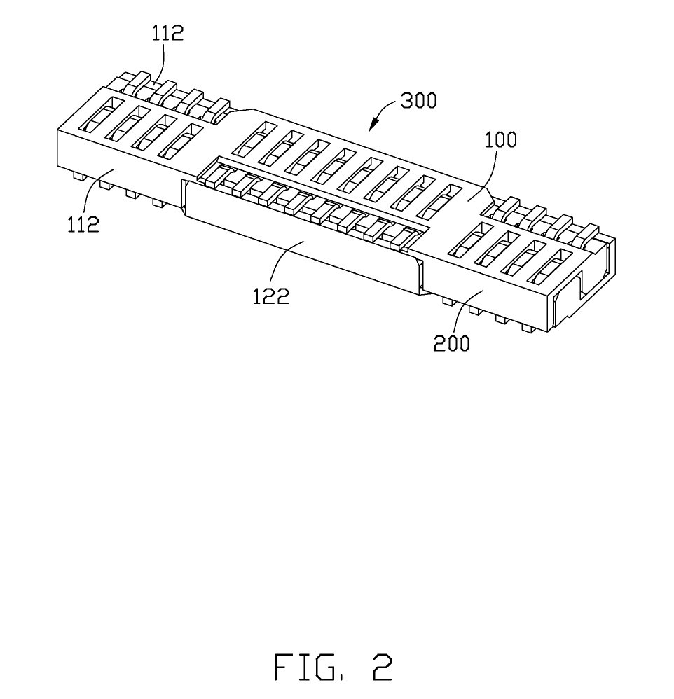

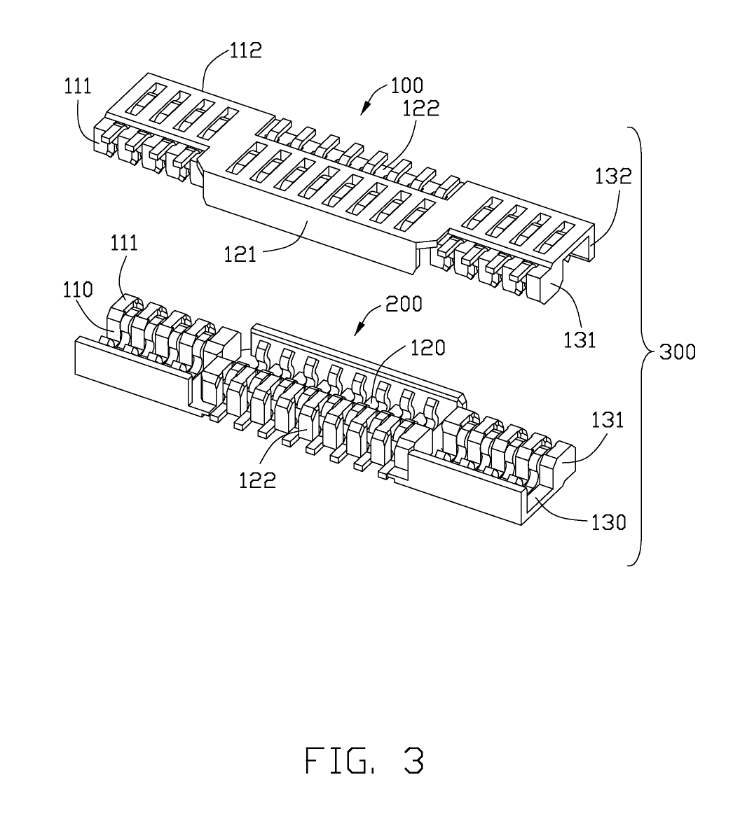

Reference will now be made to the drawing figures to describe the preferred embodiment of the present disclosure in detail. As shown in FIGS. 1 to 3 and 9, the illustrated embodiment of the present disclosure discloses a board to board connector assembly 300 including a plug connector 100 and a receptacle connector 200 for connecting two PCBs 400 electrically. The plug connector 100 and the receptacle connector 200 are truly identical and have the same structure for saving costs and reducing inventory. It is understandable to those of ordinary skill in the art that either the plug connector 100 or the receptacle connector 200 can be regarded as a board to board connector.

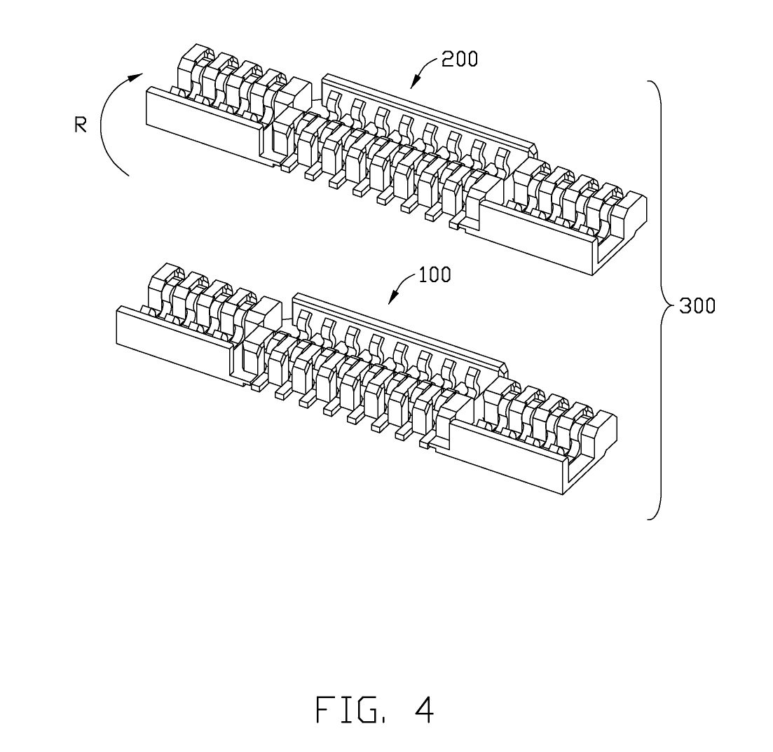

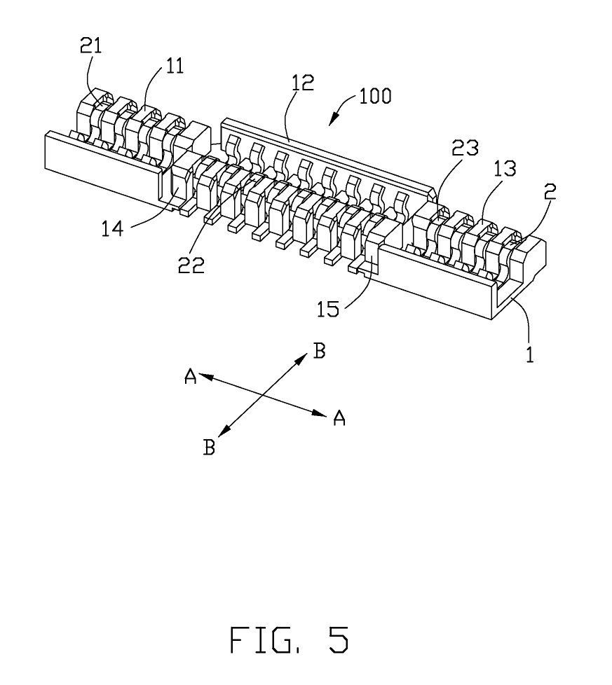

Referring to FIGS. 4 and 5, since the plug connector 100 and the receptacle connector 200 have the same configuration, only the plug connector 100 will be taken for example and described in detail. Further referring to FIGS. 5 to 7, the plug connector 100 includes an insulative housing 1 and a plurality of contacts 2 installed in the insulative housing 1. The insulative housing 1 extends along a longitudinal direction A-A and is generally defined into three segments designated as a first segment 11, a second segment 12 and a third segment 13, among which the first segment 11 and the third segment 13 are in alignment with each other along the longitudinal direction A-A, while the first segment 11 and the second segment 12 are offset from each other as viewed from the longitudinal direction A-A. As shown in FIG. 5, the first segment 11 and the second segment 12 are connected by a first connection wall 14 therebetween, and the second segment 12 and the third segment 13 are connected by a second connection wall 15 therebetween. The first connection wall 14 and the second connection wall 15 make the structure of the insulative housing 1 more robust.

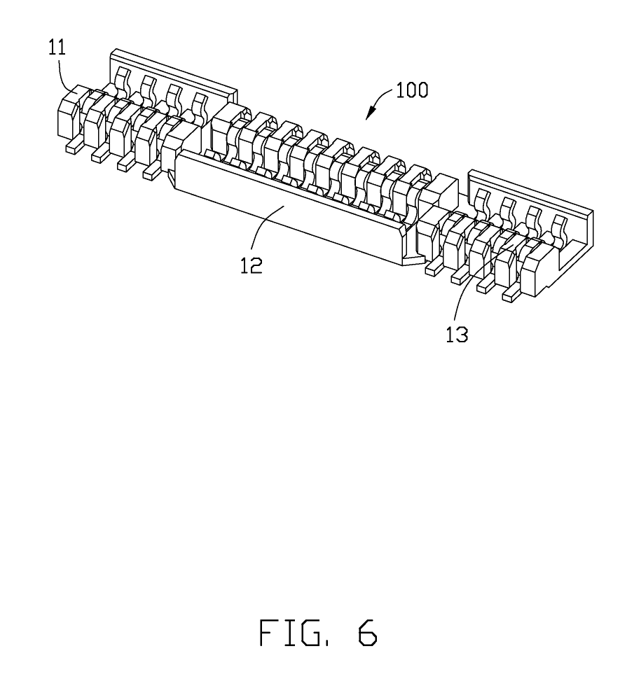

Further referring to FIGS. 6 to 8, the first segment 11 includes a first side wall 111, a second side wall 112 opposite to the first side wall 111 with a first cavity 110 formed therebetween and a plurality of first contact-receiving slots 113 each extending from the first side wall 111 to the second side wall 112 along a transverse direction B-B perpendicular to the longitudinal direction A-A. The first side wall 111 is wider than the second side wall 112 along the transverse direction B-B and is lower than the second side wall 112 along a vertical direction.

The second segment 12 includes a third side wall 121, a fourth side wall 122 opposite to the third side wall 121 with a second cavity 120 formed therebetween and a plurality of second contact-receiving slots 123 each extending from the third side wall 121 to the fourth side wall 122 along the transverse direction B-B. The fourth side wall 122 is wider than the third side wall 121 along the transverse direction B-B and is lower than the third side wall 121 along the vertical direction. Besides, from an integral viewpoint of the insulative housing 1, since the first segment 11 and the second segment 12 are offset from each other viewed along the longitudinal direction A-A, the first and the third side walls 111, 121, the second and the fourth side walls 112, 122, and the first and the second cavities 110, 120 are offset viewed along the longitudinal direction A-A. However, with the wider first and the fourth side walls 111, 122 located opposite to each other, the whole structure of the insulative housing 1 can be balanced and normal forces thereof can also be well balanced, accordingly.

The third segment 13 is the same as the first segment 11 and includes a fifth side wall 131, a sixth side wall 132 opposite to the fifth side wall 131 with a third cavity 130 formed therebetween and a plurality of third contact-receiving slots 133 each extending from the fifth side wall 131 to the sixth side wall 132 along the transverse direction B-B. The fifth side wall 131 is wider than the sixth side wall 132 along the transverse direction B-B and is lower than the sixth side wall 132 along the vertical direction.

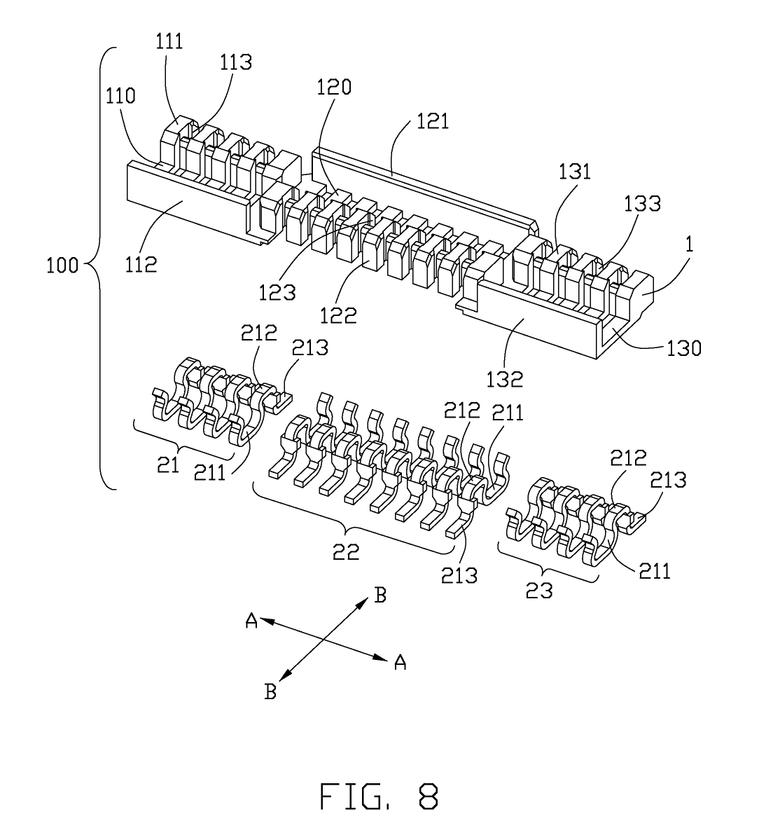

Referring to FIGS. 8 to 10, the contacts 2 include a plurality of first contacts 21 received in the first contact-receiving slots 113, a plurality of second contacts 22 received in the second contact-receiving slots 123, and a plurality of third contacts 23 received in the third contact-receiving slots 133. The first contacts 21, the second contacts 22 and the third contacts 23 respectively constitute three groups for mating with corresponding three segments 11, 12, 13 of the insulative housing 1. Although the first and the second contacts 21, 22 are fixed to the insulative housing 1 in different configurations, the first and the second contacts 21, 22 can be compatible with a single contact structure from the same part number. Obviously, the second contacts 22 can be achieved by rotating the first contacts 21 180 degrees in a horizontal plane defined by the longitudinal direction A-A and the transverse direction B-B.

According to the illustrated embodiment of the present disclosure, the first contacts 21, the second contacts 22 and the third contacts 23 have essentially the same structure and therefore only one of them will be described in detail. Each contact 2 includes a U-shaped contacting portion 211 protruding into the corresponding first, the second and the third cavities 110, 120, 130, a reversed L-shaped mounting portion 212 extending sidewardly and downwardly from the U-shaped contacting portion 211 and a horizontal soldering portion 213 extending sidewardly from the mounting portion 212.

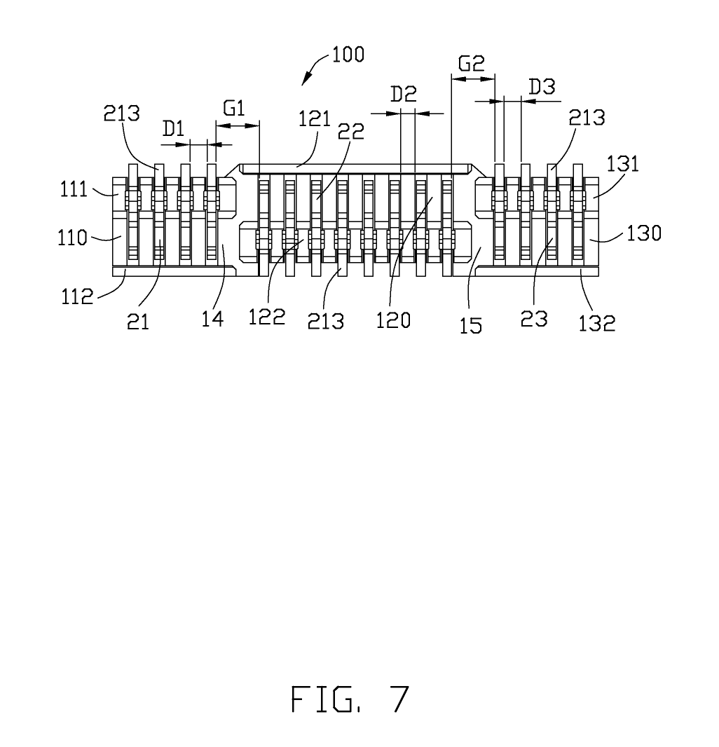

Referring to FIG. 7, the soldering portion 213 of the first contacts 21 and the soldering portion 213 of the second contacts 22 are located on opposite sides of the insulative housing 1, which avoids the soldering portion 213 of the three contact groups intervening with each other so as to facilitate reflowing soldering. Besides, with the first connection wall 14 located between the first contacts 21 and the second contacts 22, a gap G1 between the closest first contact 21 and the second contact 22 is greater than a first distance D1 between each adjacent first contacts 21 and a second distance D2 between each adjacent second contacts 22. Similarly, with the second connection wall 15 located between the second contacts 22 and the third contacts 23, a gap G2 between the closest second contact 22 and the third contact 23 is greater than the second distance D2 between each adjacent second contacts 21 and a third distance D3 between each adjacent third contacts 23. As a result, both the first connection wall 14 and the second connection wall 15 make the structure of the insulative housing 1 more robust.

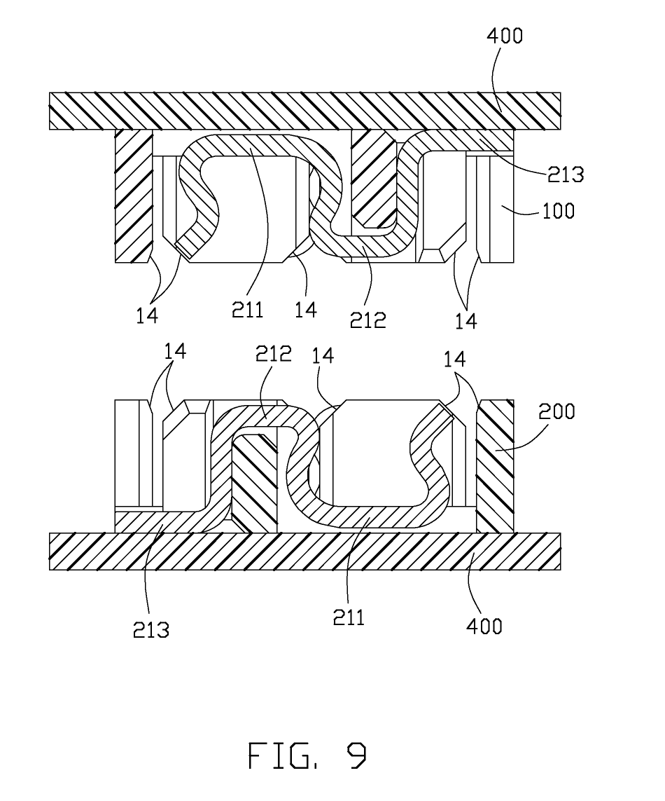

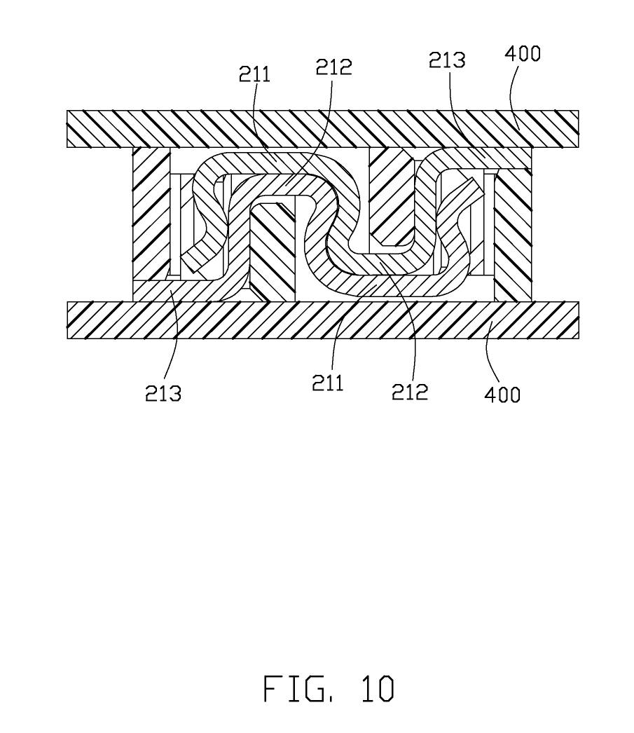

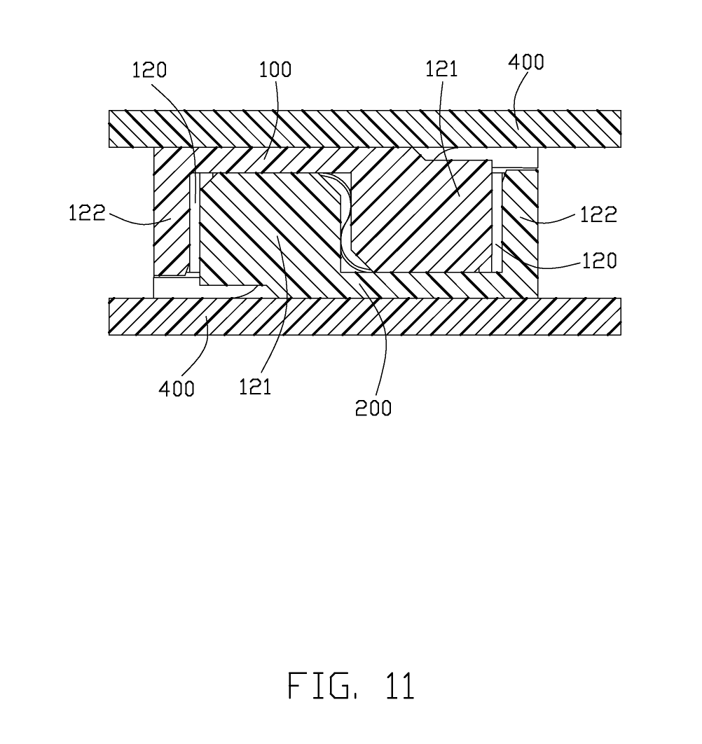

Referring to FIGS. 9 to 11, each side wall 111, 112, 121, 122, 131, 132 of the insulative housing 1 includes an inclined portion 14 at a distal end thereof for guiding insertion of the plug connector 100 and the receptacle connector 200. As shown in FIGS. 1 to 3, when the plug connector 100 and the receptacle 200 are mated with each other under such guiding structures, the first side wall 111 of the plug connector 100 is received in the first cavity 110 of the receptacle connector 200, the second side wall 112 of the plug connector 100 is located sidewardly to the first side wall 111 of the receptacle connector 200 along the transverse direction B-B, the fourth side wall 122 of the plug connector 100 is received in the second cavity 120 of the receptacle connector 200, the third side wall 121 of the plug connector 100 is located sidewardly to the fourth side wall 122 of the receptacle connector 200 along the transverse direction B-B, the fifth side wall 131 of the plug connector 100 is received in the third cavity 130 of the receptacle connector 200, and the sixth side wall 132 of the plug connector 100 is located sidewardly to the fifth side wall 131 of the receptacle connector 200 along the transverse direction B-B. After the plug connector 100 and the receptacle connector 200 are mated with each other, the second side wall 112 and the third side wall 121 of the plug connector 100 are in alignment with the third side wall 122 and the second side wall 112 of the receptacle connector 200 along the longitudinal direction, respectively. As a result, the plug connector 100 and the receptacle connector 200 jointly form a rectangular shape for saving space. Under this condition, as shown in FIG. 10, the mounting portions 212 of the plug connector 100 are received in the U-shaped contacting portions 211 of the receptacle connector 200, and simultaneously, the mounting portions 212 of the receptacle connector 200 are received in the U-shaped contacting portions 211 of the plug connector 100. Besides, in order to assure contacting stability of the plug connector 100 and the receptacle connector 200, the contacts 2 of the plug connector 100 and corresponding contacts 2 of the receptacle connector 200 are engaging with each other at three points distributed along the transverse direction B-B.

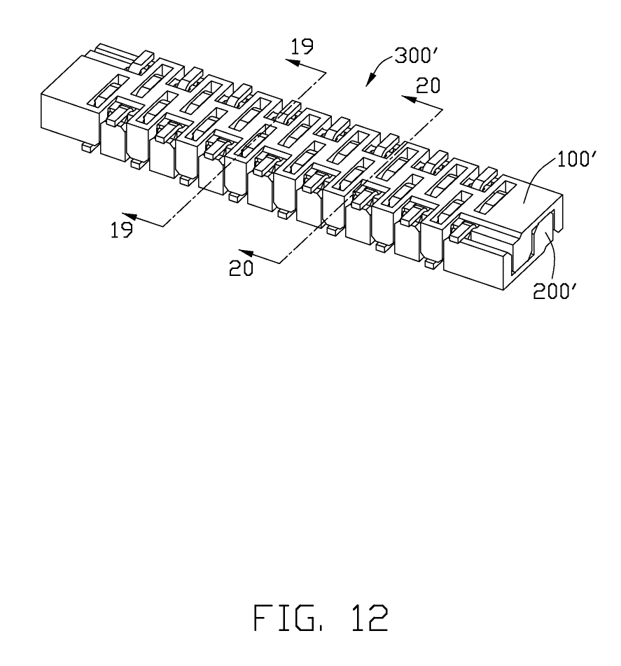

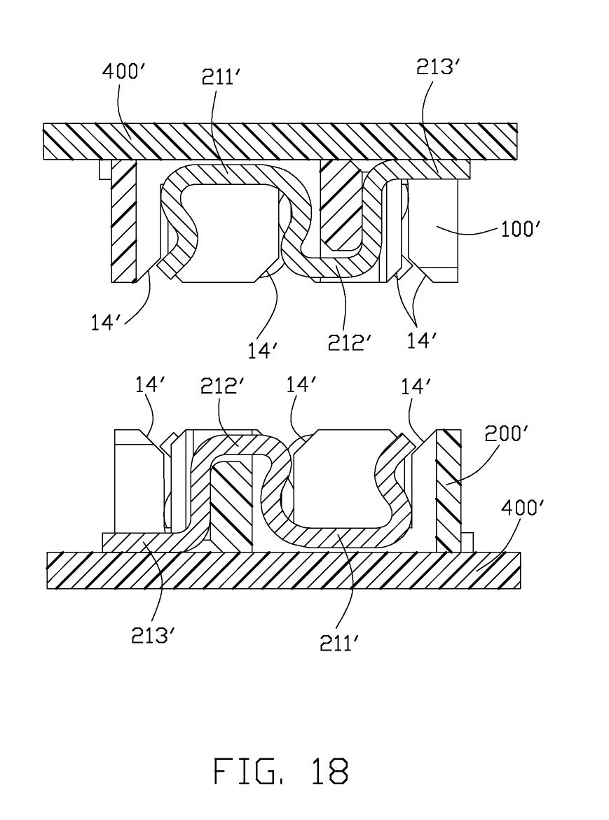

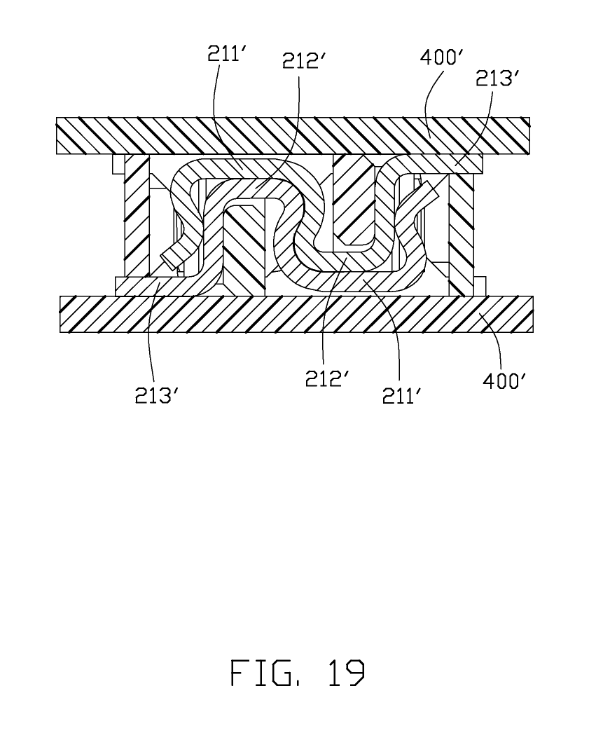

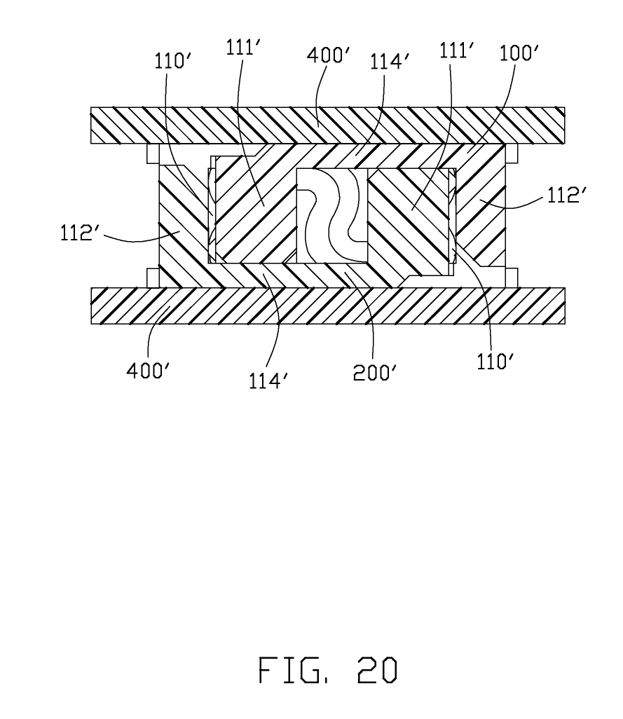

Referring to FIGS. 12 to 20, a second embodiment of the present disclosure discloses another board to board connector assembly 300′ similar to the board to board connector assembly 300 in the first embodiment. Since it is understandable to those of ordinary skill in the art, in combination with the FIGS. 1 to 11 and corresponding description of the first embodiment, to understand the board to board connector assembly 300′, repeated description and similar description are omitted herein. In accordance with the second embodiment of the present disclosure, the board to board connector assembly 300′ includes a plug connector 100′ and a receptacle connector 200′ respectively mounted on two PCBs 400′ for electrically connecting the two circuit boards 400′. The plug connector 100′ and the receptacle connector 200′ are truly identical for saving costs and reducing inventory.

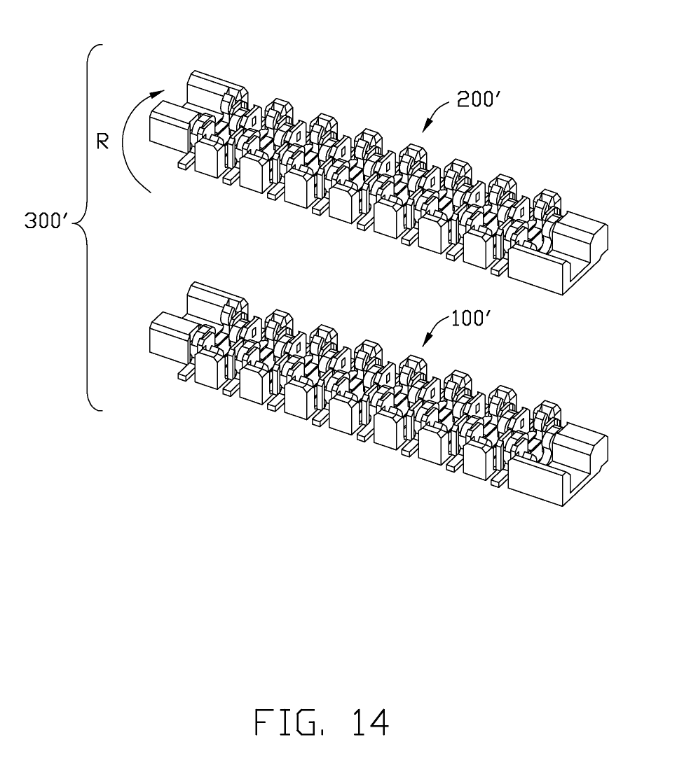

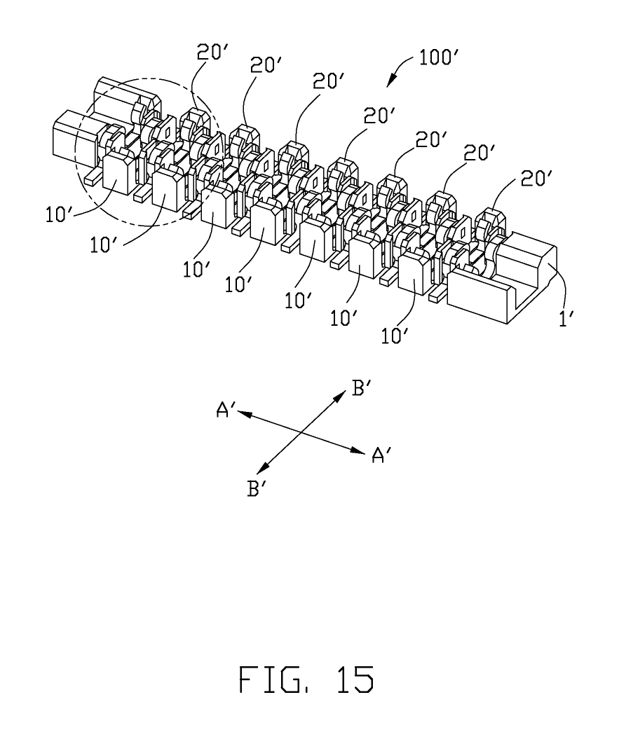

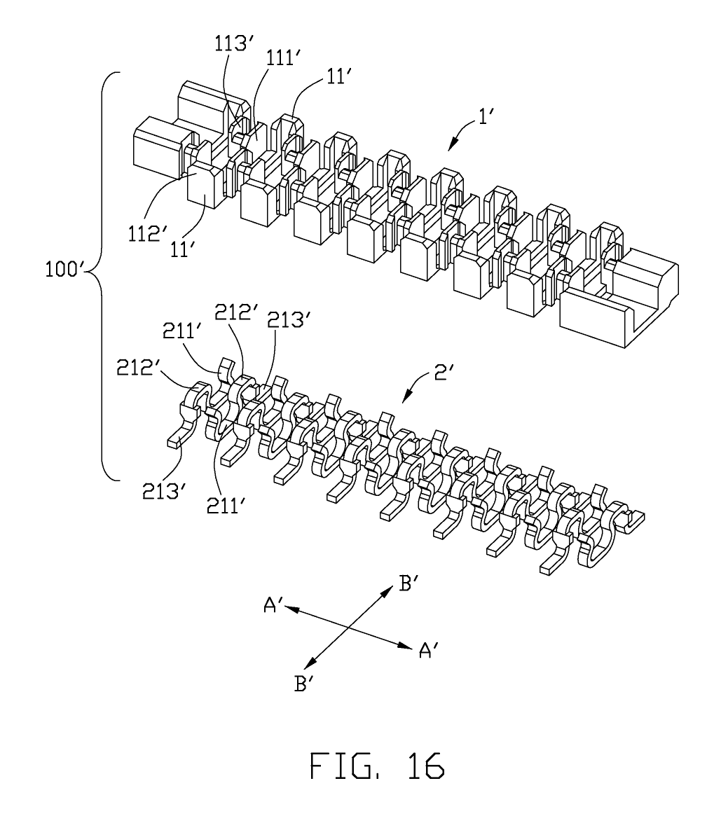

Referring to FIG. 14, since the plug connector 100′ and the receptacle connector 200′ have the same configuration, only the plug connector 100′ will be taken for example and described from a module viewpoint. Further referring to FIGS. 15 and 16, the plug connector 100′ includes a plurality of first pattern modules 10′ and a plurality of second pattern modules 20′ alternately connected with each other along a longitudinal direction A′-A′. Although the first pattern modules 10′ and the second pattern modules 20′ have different configurations, they have some special relationships, which will be described in detail hereinafter.

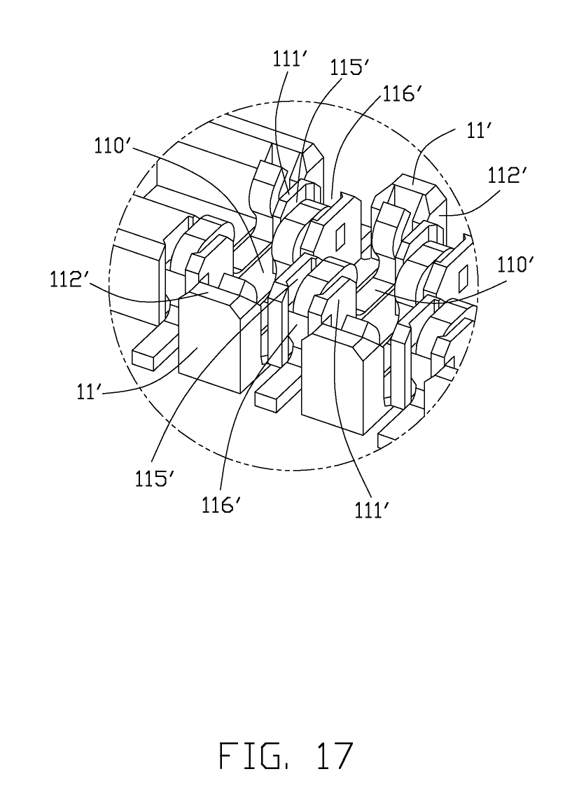

Referring to FIGS. 15 to 17, each of the first pattern modules 10′ and each of the second pattern modules 20′ includes an insulative body 11′ and a plurality of contacts 2′ fixed in the insulative body 11′. Each insulative body 11′ includes a bottom wall 114′, a first side wall 111′, a second side wall 112′ opposite to the first side wall 111′ with a cavity 110′ formed therebetween, and a contact-receiving slot 113′ extending along a transverse direction B′-B′ perpendicular to the longitudinal direction A′-A′. The first side wall 111′ is wider than the second side wall 112′ along the transverse direction B′-B′. The contact-receiving slot 113′ is sinuous and includes a first slot 115′ recessed from a top surface of the first side wall 111′ and a second slot 116′ recessed from an out surface of the first side wall 111′. The contacts 2′ are received in the contact-receiving slots 113′ and protrude into the cavity 110′. The transverse direction B′-B′ and the longitudinal direction A′-A′ jointly define a horizontal plane. As shown in FIG. 17 , each second pattern module 20′ is constructed as a mirrored image of each first pattern module 10′ with 180 degrees rotation in the horizontal plane and the first pattern modules 10′ are offset from the second pattern modules 20′ as viewed along the longitudinal direction A′-A′.

The contacts 2′ have essentially the same structure as the contacts 2 of the first embodiment. Each contact 2′ includes a U-shaped contacting portion 211′ protruding into the cavity 110′, a reversed L-shaped mounting portion 212′ extending sidewardly and downwardly from the U-shaped contacting portion 211′ and a horizontal soldering portion 213′ extending sidewardly from the mounting portion 212′. Referring to FIG. 17, the soldering portions 213′ of the first pattern modules 10′ and the soldering portions 213′ of the second pattern modules 20′ are located on opposite sides of an insulative housing 1′, which avoids the soldering portions 213′ of the contacts 2′ intervening with each other so as to facilitate reflowing soldering. In assembling, the U-shaped contacting portions 211′ are exposed to cavity 110′ and the mounting portions 213′ are received in the first and the second slots 115′ 116′. Besides, the mounting portions 212′ do not exceed the top surface of the first side wall 111′ along a vertical direction perpendicular to the transverse direction B′-B′ and the longitudinal direction A′-A′ for protection.

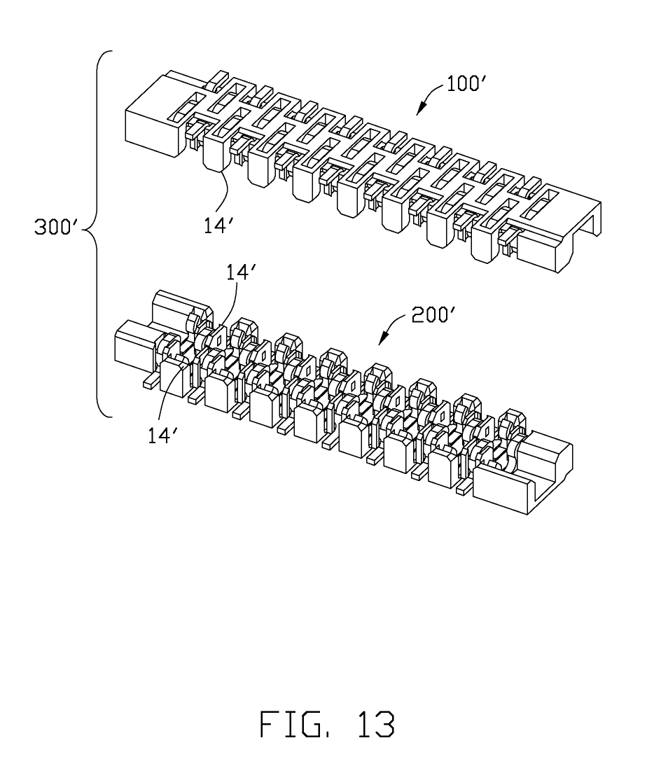

Referring to FIGS. 13 and 18 to 20, each of the first side walls 111′ and the second side walls 112′ includes an inclined guiding portion 14′ at a top distal end thereof for guiding insertion of the plug connector 100′ and the receptacle connector 200′. When the plug connector 100′ and the receptacle 200′ are mated with each other under such guiding structures, the first side wall 111′ of the plug connector 100′ is received in the cavity 110′ of the receptacle connector 200′, the second side wall 112′ of the plug connector 100′ is located sidewardly to the first side wall 111′ of the receptacle connector 200′ along the transverse direction B′-B′. In other words, the first side wall 111′ of the first pattern module 10′ of the plug connector 100′ is situated between the first and the second side walls 111′, 112′ of the second pattern module 20′ of the receptacle connector 200′ along the transverse direction B′-B′. Under this condition, the mounting portions 212′ of the plug connector 100′ are received in the U-shaped contacting portions 211′ of the receptacle connector 200′, and simultaneously, the mounting portions 212′ of the receptacle connector 200′ are received in the U-shaped contacting portions 211′ of the plug connector 100′. Besides, in order to assure contacting stability of the plug connector 100′ and the receptacle connector 200′, the contacts 2′ of the plug connector 100′ and corresponding contacts 2′ of the receptacle connector 200′ are engaging with each other at three points distributed along the transverse direction B′-B′.

It is to be understood, however, that even though numerous, characteristics and advantages of the present disclosure have been set forth in the foregoing description, together with details of the structure and function of the invention, the disclosed is illustrative only, and changes may be made in detail, especially in matters of number, shape, size, and arrangement of parts within the principles of the invention to the full extent indicated by the broadest general meaning of the terms in which the appended claims are expressed.

What is claimed is:

1. A hermaphroditic board to board connector assembly comprising:
a plug connector and a receptacle connector with a same configuration with the plug connector, the plug connector and the receptacle connector each comprising:
an insulative housing comprising a first segment, a second segment, and a connection wall connected between the first segment and the second segment, the first segment comprising a first side wall, a second side wall opposite to the first side wall with a first cavity formed therebetween, a plurality of first contact-receiving slots each extending along a transverse direction, the second segment comprising a third side wall, a fourth side wall opposite to the third side wall with a second cavity formed therebetween, a plurality of second contact-receiving slots each extending along the transverse direction, the second side wall and the third side wall being opposite to each other; and
a plurality of first and second contacts respectively received in the first contact-receiving slots and the second contact-receiving slots and respectively protruding into the first cavity and the second cavity; wherein
the first cavity and the second cavity extend along a longitudinal direction perpendicular to the transverse direction while offset from each other as viewed along the longitudinal direction; and wherein
when the plug connector and the receptacle connector are mated with each other, the first side wall of the plug connector is received in the first cavity of the receptacle connector and the second side wall of the plug connector is located sidewardly to the first side wall of the receptacle connector along the transverse direction, and the fourth side wall of the plug connector is received in the second cavity of the receptacle connector and the third side wall of the plug connector is located sidewardly to the fourth side wall of the receptacle connector along the transverse direction.

2. The hermaphroditic board to board connector assembly as claimed in claim 1, wherein when the plug connector and the receptacle connector are mated with each other, the second side wall and the third side wall of the plug connector are in alignment with the third side wall and the second side wall of the receptacle connector along the longitudinal direction, respectively.

3. The hermaphroditic board to board connector assembly as claimed in claim 1, wherein the first side wall is wider than the second side wall along the transverse direction, and the fourth side wall is wider than the third side wall along the transverse direction.

4. The hermaphroditic board to board connector assembly as claimed in claim 1, wherein because of the connection wall, a gap between the first contact and the second contact closest with each other is greater than that between each adjacent first contacts and each adjacent second contacts.

5. The hermaphroditic board to board connector assembly as claimed in claim 1, wherein the first side wall of the plug connector comprises a first inclined portion at a distal end thereof, and the second side wall of the receptacle connector comprises a second inclined portion cooperated with the first inclined portion for guiding insertion of the plug connector and the receptacle connector.

6. The hermaphroditic board to board connector assembly as claimed in claim 1, wherein each of the first contact and the second contact comprises a U-shaped contacting portion, a reversed L-shaped mounting portion extending sidewardly and downwardly from the U-shaped contacting portion and a horizontal soldering portion extending sidewardly from the mounting portion.

7. The hermaphroditic board to board connector assembly as claimed in claim 6, wherein when the plug connector and the receptacle connector are mated with each other, the mounting portions of the first and the second contacts of the plug connector are received in the U-shaped contacting portions of the first and the second contacts of the receptacle connector, and simultaneously, the mounting portions of the first and the second contacts of the receptacle connector are received in the U-shaped contacting portions of the first and the second contacts of the plug connector.

8. The hermaphroditic board to board connector assembly as claimed in claim 6, wherein when the plug connector and the receptacle connector are mated with each other, corresponding first contacts of the plug connector and the receptacle connector are engaging with each other at three points distributed along the transverse direction, and likewise, corresponding second contacts of the plug connector and the receptacle connector are engaging with each other at three points distributed along the transverse direction.

9. The hermaphroditic board to board connector assembly as claimed in claim 6, wherein the soldering portions of the first contacts of the plug connector and the soldering portions of the second contacts of the plug connector are located on opposite sides of the insulative housing.

10. The hermaphroditic board to board connector assembly as claimed in claim 1, wherein the insulative housing comprises a third segment opposite to the first segment along the longitudinal direction under condition that the first segment and the third segment are in alignment with each other along the longitudinal direction while the first segment and the second segment are offset from each other as viewed along the longitudinal direction.

11. An electrical connector comprising:
a plurality of first pattern modules and a plurality of second pattern modules alternately connected with each other along a longitudinal direction;
each of the first and the second pattern modules comprising:
an insulative body comprising a bottom wall, a first side wall, a second side wall opposite to the first side wall with a cavity formed therebetween, and a contact-receiving slot extending along a transverse direction perpendicular to the longitudinal direction, the transverse direction and the longitudinal direction jointly defining a horizontal plane; and
a plurality of contacts received in the contact-receiving slot and protruding into the cavity; wherein
the second pattern module is constructed as a mirrored image of the first pattern module with 180 degrees rotation in the horizontal plane; and the first side wall of the first pattern module is situated between the first and the second side walls of an adjacent second pattern module along the transverse direction.

12. The electrical connector as claimed in claim 11, wherein the contact-receiving slot comprises a first slot recessed from a top surface of the first side wall and a second slot recessed from an out surface of the first side wall, each contact comprising a U-shaped contacting portion exposed to cavity and a reversed L-shaped mounting portion received in the first and the second slots.

13. The electrical connector as claimed in claim 12, wherein the U-shaped contacting portion and the reversed L-shaped mounting portion commonly provide three points distributed along the transverse direction for engaging with a mateable connector.

14. The electrical connector as claimed in claim 11, wherein the electrical connector is hermaphroditic and is mateable with an identical electrical connector for connecting two circuit boards on which the electrical connector and the identical electrical connector are mounted, respectively.

15. The electrical connector as claimed in claim 11, wherein the first side wall and the second side wall comprise inclined guiding portions at top distal ends thereof for guiding insertion of an identical mateable connector.

16. The electrical connector as claimed in claim 11, wherein the first pattern modules are offset from the second pattern modules as viewed along the longitudinal direction.

17. An electrical connector assembly comprising:
a connector including an insulative housing extending along a longitudinal direction;
a plurality of first contacts disposed in the housing; and
a plurality of second contacts having a same number with the first contacts and disposed in the housing under condition that the second contacts is essentially of a mirror image with regard to the first contact in a transverse direction perpendicular to said longitudinal direction so that a total force-balanced arrangement is achieved in both the longitudinal direction and the transverse direction when the connector is mated with another identical connector in a vertical direction perpendicular to both said longitudinal direction and said transverse direction.

18. The electrical connector assembly as claimed in claim 17, wherein said first contacts are arranged in one group while said second contacts are arranged with two groups of the same number and located respectively at two ends of the group formed by the first contacts in the longitudinal direction.

19. The electrical connector assembly as claimed in claim 17, wherein each of the first contacts or the second contacts defines a protruding mating section extending from a tail section, and a recessed mating section extending from the protruding mating section opposite to the tail section in the transverse direction under condition that the protruding mating section defines an stiff outer region, the recessed mating section defines a resilient outer region, and a resilient inner region is shared by both said protruding mating and said recessed mating section.

20. The electrical connector assembly as claimed in claim 19, wherein the resilient region is located adjacent to a centerline of the housing extending along the longitudinal direction.
